(19) United States
(12) Patent Application Publication
(10) Pub. No.: US 2011/0210632 A1
(43) Pub. Date: Sep. 1, 2011

(54) Driving device of an electric motor

(76) Inventor: Jian-Sheng Ding, Taipei (TW)

(21) Appl. No.: 12/805,764

(22) Filed: Aug. 19, 2010

(30) Foreign Application Priority Data
Feb. 26, 2010 (TW) 099202528

(51) Int. Cl. H02K 47/14; H02K 53/00

(52) U.S. Cl. 310/113; 415/916

(57) ABSTRACT

A driving device of an electric motor for generating power is characterized by that: said driving device comprises: multiples support bars arranged at interval, a drive shaft penetrating the support bars, at least four weight wheels penetrated and secured by the drive shaft, a first driving wheel pivotally mated with the drive shaft and driven by the electric motor, and at least a second driving wheel pivotally mated with the drive shaft and used to energize the generator; four weight wheels are arranged at both sides of every support bar in pairs, so that the driving device forms a two driving portions, and the support bar is fitted with a drive bearing penetrated by the drive shaft.

### BACKGROUND OF INVENTION

1. Field of the Invention

The present invention relates generally to a driving device of an engine, and more particularly to an electric motor.

2. Description of Related Art

In an attempt to obtain electric energy from solar energy, to hydraulic energy and wind energy, the human beings have developed many devices including: external combustion engine (ECE), internal combustion engine (ICE), electric motor, solar energy device, wind generator and hydraulic generator, etc.

The defects of the conventional design are as follow:

1. ECE: big-sized, high consumption of fuel and water, consequent environmental pollution from exhaust emission.

2. ICE: complex construction, high energy consumption and environmental pollution the same with ECE.

3. Electric motor: powered by battery; the electric motor shall be replaced in the event of damage.

4. Solar energy device: restricted by time or climate; the conversion rate of solar ray into electricity is proportional to the quantity of solar panels; the unfolded absorbing panel has the disadvantage of space utilization.

5. Wind generator: the stability of power generation is affected by the strength of wind; the generator is generally deployed in the regions with strong and non-stop wind.

6. Hydraulic generator: restricted by geographical conditions as the wind generator; generally deployed in torrential rivers.

Thus, to overcome said problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

An improved driving device of an electric motor, wherein the input end of the driving device (1) is driven by the electric motor (3), and the output end of the driving device (1) supplies power to the generator (2), which permits the generated electric power to be stored into electrical storage device 4; then, the electrical storage device 4 supplies power to said electric motor (3) and drives the driving device (1); it is characterized by that:

Said driving device (1) comprises: several support bars (12) arranged at interval, a drive shaft (13) penetrating the coupling portion of support bars (12), at least four weight wheels (141, 142, 143, 144) penetrated and secured by the drive shaft (13), a first driving wheel (151) pivotally mated with the drive shaft (13) and driven by the electric motor (3), and at least a second driving wheel (152) pivotally mated with the drive shaft (13) and used to energize the generator (2); said weight wheels (141˜144) are arranged at both sides of every support bar (12) in pairs, so that the driving device (1) forms a first driving portion la and a second driving portion 1b, and the support bar (12) is fitted with a drive bearing (122) penetrated by the drive shaft (13).

The following benefits can be achieved from the present invention:

1. The driving device (1) of the present invention mainly comprises at least four weight wheels (141˜144), at least two drive to wheels (151, 152) and drive bearing (122), together with the casing seat (101) and two casing covers 102, 103 of the casing (10), so that two driving portions 1a, 1b are formed on the driving device (1); in such case, the first driving wheel (151) or second driving wheel (152) is arranged at central section of the drive shaft (13), and belts (22, 32) passing the casing opening (11) are coupled with the electric motor or generator.

2. Said driving device (1) is driven by the electric motor (3) to avoid power generation by means of conventional fuel transmission; and during the process of power transmission, the driving device (1) without consumption of fuel enables to reduce environmental pollution.

3. Said driving device (1) allows to set a mobile ring (50) into the casing (10); during the process of power transmission, the mobile ring (50) allows the loosened weight wheel to rotate continuously and reduce the influence on the drive shaft (13) until shutdown for repair or replacement.

4. Said driving device (1) permits flexible configuration such that two drive wheels (151, 152) are arranged at central section of the drive shaft (13), and said generator (2) and electric motor (3) can be placed between the second weight wheel (142) and third weight wheel (143), enabling the second preferred embodiment of the driving device to be used in long and narrow environment.

5. Said driving device (1) is additionally provided with fifth weight wheel (145) and sixth weight wheel (146), as well as two second driving wheels (153, 154); while two generators (2) are driven separately for operation, it can be connected in series with the other same driving device (1′), and taken as a power supply for the driving device (1′) in the case of failure of the electric motor (3′) of the driving device (1′).

### BRIEF DESCRIPTION OF THE DRAWINGS

FIG. 1 shows the first preferred embodiment of the driving device of the present invention.

FIG. 2 shows top sectional view that the driving device is placed in the casing as shown in FIG. 1.

FIG. 2-1 shows a full sectional view of X-Y in FIG. 2.

FIG. 2-2 shows a full sectional view of Y-Y in FIG. 2.

FIG. 2-3 shows a 3D schematic view of four weight wheels in FIG. 2.

FIG. 2-4 shows a sectional view of the driving device in FIG. 2.

FIG. 3 shows the second preferred embodiment of the driving device of the present invention.

FIG. 4 shows the third preferred embodiment of the driving device of the present invention.

### DETAILED DESCRIPTION OF THE PREFERRED EMBODIMENTS

The preferred embodiments of the present invention are described in detail hereinafter according to the appended drawings:

### First Embodiment

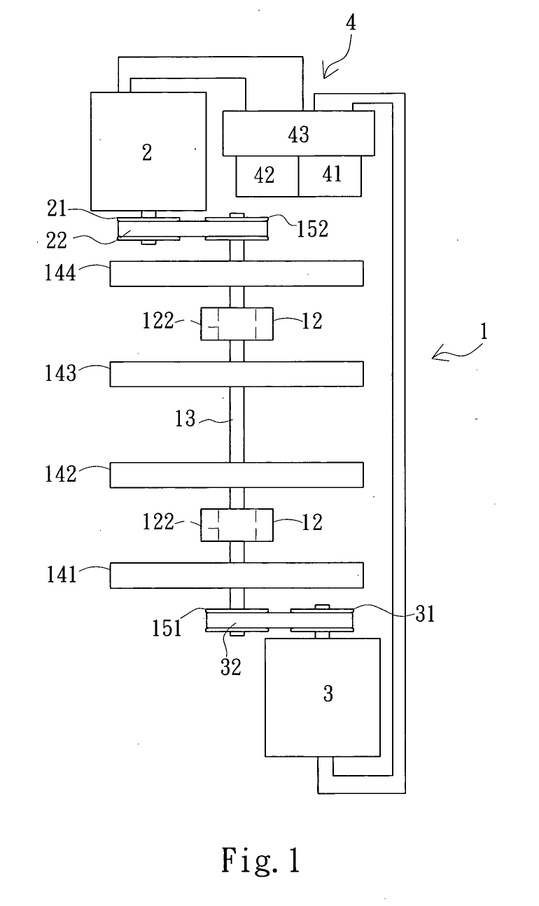

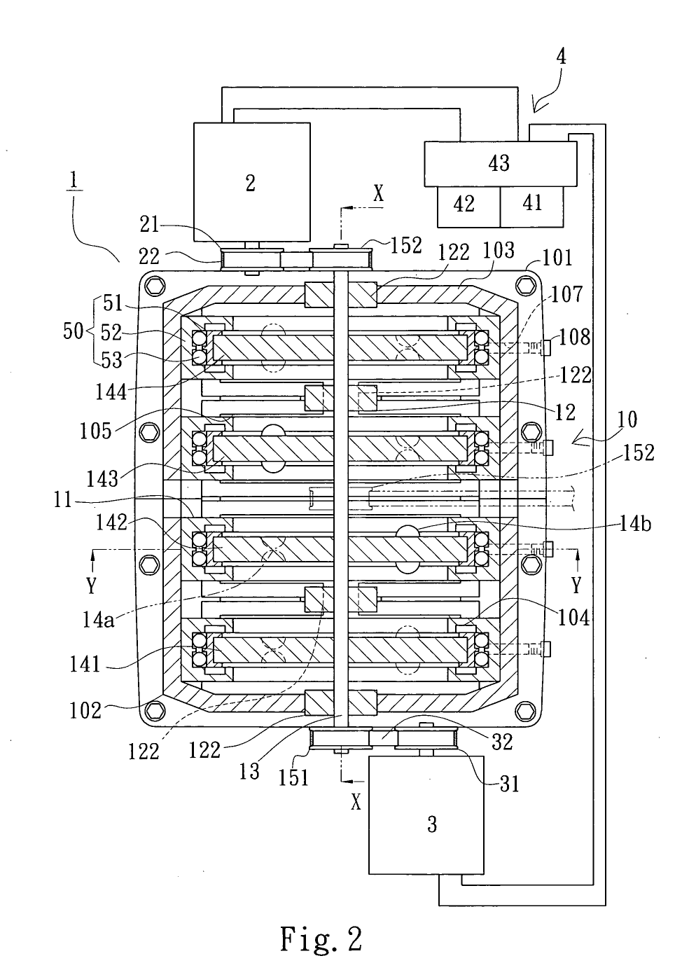

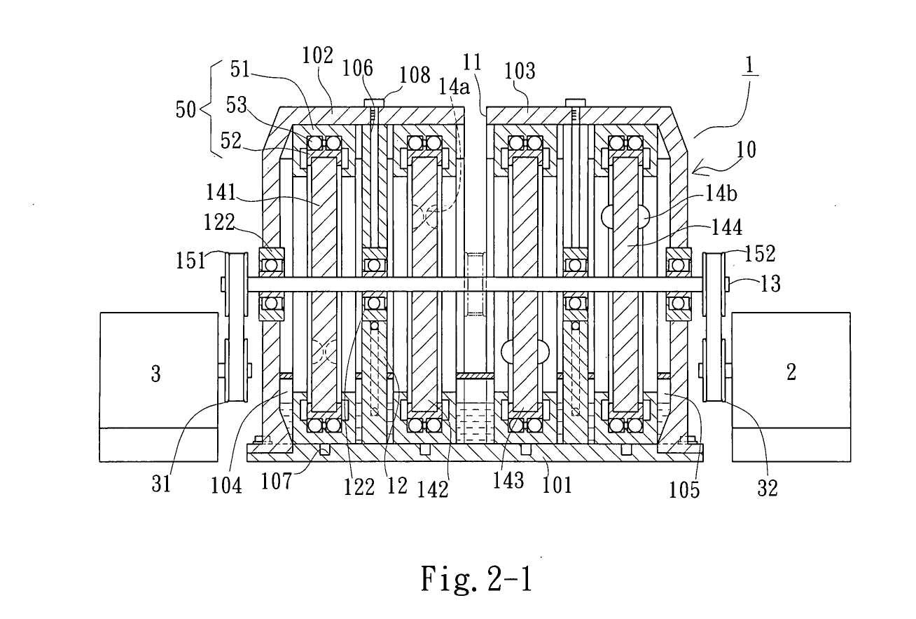

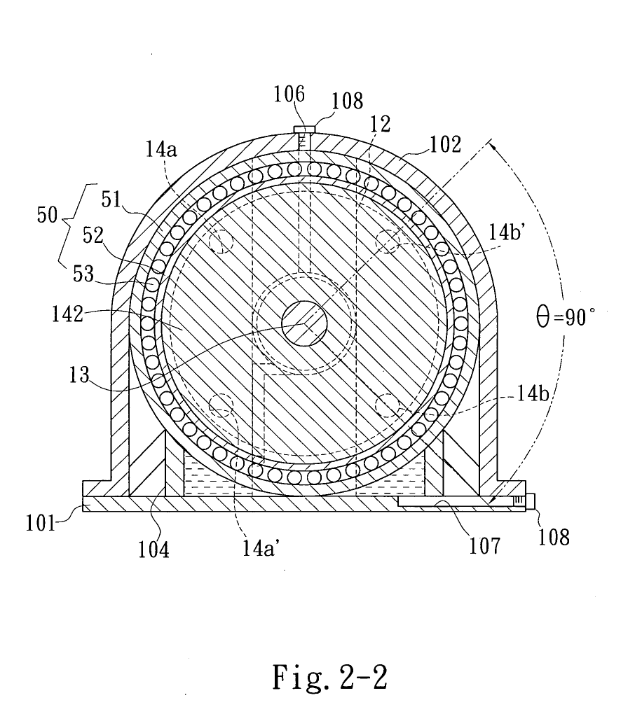

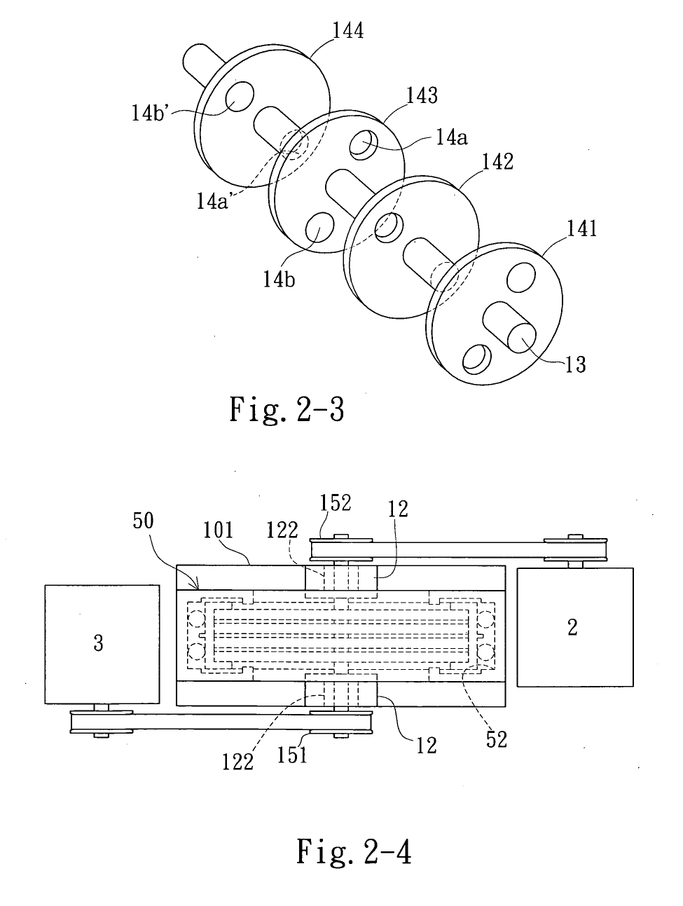

Referring to FIG. 1, FIG. 2, FIG. 2-1, FIG. 2-2, FIG. 2-3 and FIG. 2-4, the present invention is characterized by that, the driving device (1) mainly comprises: several support bars (12) arranged at interval, a drive shaft (13) penetrating the coupling portion of support bars (12), at least four weight wheels (141, 142, 143, 144) penetrated and secured by the drive shaft (13), a first driving wheel (151) pivotally mated with the drive shaft (13) and driven by the electric motor (3), and at least a second driving wheel (152) pivotally mated with the drive shaft (13) and used to energize the generator (2); said weight wheels (141˜144) are arranged at both sides of every support bar (12) in pairs, so that the driving device (1) forms a first driving portion 1a and a second driving portion 1b, and the support bar (12) is fitted with a drive bearing (122) penetrated by the drive shaft (13).

Based on said structure, the driving device. (1) of the present invention can be driven by the electric motor (3) to avoid power generation by means of conventional fuel transmission; and during the process of power transmission, the driving device (1) without consumption of fuel enables to reduce environmental pollution.

Said four weight wheels (141˜144) include the first weight wheel (141), second weight wheel (142), third weight wheel (143) and fourth weight wheel (144), which are configured onto the drive shaft (13) in conjunction with said drive bearing (122) and two drive wheels (151, 152), as shown in FIG. 1, including: the first driving wheel (151), the first weight wheel (141), the drive bearing (122), the second weight wheel (142), the third weight wheel (143), the drive bearing (122), the fourth weight wheel (144) and the second driving wheel (152); the second driving wheel (152) is used to drive the rotating disc (21) of the generator (2) via a belt (22), while the driving disc (31) of the electric motor (3) is also used to drive the first driving wheel (151) of the driving device (1) via belt (32).

Said first and second driving wheels (151, 152), rotating disc (21) and driving disc (31) are implemented by gear, and the belts 22, 32 implemented by toothed belt. Similar to a ring-oiled sleeve bearing, said drive bearing (122) allows for visual inspection to determine if the oil ring is rotating. And, the scale position of oil gauge can be observed through the oil level at standstill condition.

The preferred embodiment of the driving device (1) of the present invention is shown in said figure, wherein said driving device (1) is placed into a fixed casing (10) with an opening (11), both ends of the support bar (12) are separately mated onto the top and bottom wall of the casing (10), so that said drive bearing (122) is placed at the center of the support bar (12) for penetration by the drive shaft (13). In FIG. 2-1, the inner wall surface of the casing (10) is provided with at least four mobile rings (50) that are arranged correspondingly to the weight wheels (141˜144) and used to cover the periphery of the weight wheel; the mobile ring (50) is composed of an inner ring (51) covering the periphery of the weight wheel, an outer ring cover (52) mated onto the inner wall of the casing (10) at a spacing with the inner ring (51), and several balls (53) arranged between the inner ring (51) and outer ring cover (52) to surround the inner ring (51). Said inner ring (51) is of a hollow pattern, and the loop cover flange at both sides of the outer ring cover (52) is folded inwards but kept a small clearance with the inner ring (51); in addition to lubricant infiltration, it can be abutted onto the loosening weight wheel to avoid any further possible damage.

Said casing (10) is composed of a casing seat (101) and two casing covers (102, 103) separately at two parts of the casing seat (101), enabling said opening (11) to be formed between two casing covers (102, 103); moreover, at left and right bottom of the casing (10), lubrication grooves (104, 105) (FIG. 2-2) are set for the balls (53) of said mobile ring (50), such that the mobile ring (50) can rotate smoothly under the drive of the weight wheel. The lubricant can be filled into two lubrication grooves (104, 105) through the casing opening (11), or into the support bar (12) from the filling port (106) at top of the casing covers 102, 103, and then into the lubrication grooves (104, 105) via the drive bearing (122); furthermore, the casing seat (101) is provided with a discharge pipeline (107) and leakage-proof bolts (108) screwed onto the pipe nozzle.

The driving device (1) of the present invention is arranged uniformly via four weight wheels (141˜144), and implemented in conjunction with the casing seat (101) and two casing covers (102, 103), such that the driving device (1) allows the first driving portion 1a to be formed from the first driving wheel (151) to the second weight wheel (142), and the second driving portion 1b to be formed from the third weight wheel (143) to the second driving wheel (152); in this way, the wheels and bearing of the driving device (1) are implemented in two parts; when one part of the weight wheels is loosened, said mobile ring (50) allows the loosened weight wheel to rotate continuously until shutdown for repair or replacement, or the first driving wheel (151) or second driving wheel (152) is placed at the central section of the drive shaft (13), and belts 22, 32 passing through the casing opening (11) are coupled with the electric motor or generator for temporary operation.

When the driving device (1) of the present invention is operated, four weight wheels (141˜144) could facilitate the rotation of the drive shaft (13) with their inertia; in the detailed package, a recess (14a), a projection (14b), or a recess (14a) combined with projection (14b) is arranged separately on every surface of weight wheels 141˜144, such that an included angle θ is formed between projection (14b) of a weight wheel and projection (14b′) of another weight wheel, as the case may be for recess (14a).

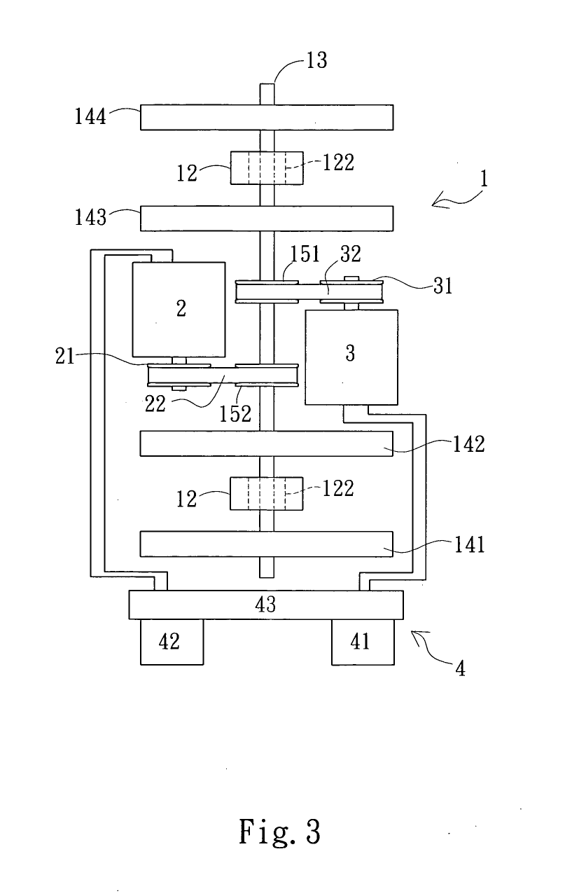

Given the same construction and shape of said four weight wheels (141˜144), as shown in FIG. 2-2, recess (14a) is arranged at half-side of the second weight wheel (142) and projection (14b) at the other half-side; when the weight of the second weight wheel (142) remains unchanged, the gravity of the weight wheel may shift, so the moment of force at half-side of the projection (14b) will be bigger than that at the other half-side, enabling rotation of the second weight wheel (142). As shown in FIG. 2-3, every weight wheel (141˜144) is rotated to an angle θ and linked by a drive shaft (13), so that the projections (14b) on the wheel surface are not aligned. The angle (θ) is evenly distributed by the quantity of weight wheels adopted by the driving device (1); the angle (θ) is 90° degrees when four weight wheels are implemented; in the case of standstill condition, four weight wheels 141˜144 are in a balanced state; when the first driving wheel (151) is driven for rotation, the moment of force of every weight wheel (141˜144) will vary, leading to smooth rotation of every weight wheel in conjunction with the mobile ring (50).

Said projection (14b) and the weight wheel are prefabricated to be implemented by protruding lugs, ribs or particles, or otherwise by securing other heavy objects onto the wheel surface; said recess (14a) is recessed into the surface of the weight wheel, or implemented by the through-holes. Also referring to FIG. 2-4—a simplified preferred embodiment of the driving device (1) of the present invention, the difference is that four weight wheels are placed into a mobile ring (50), of which the outer ring cover (52) of mobile ring (50) and the support bar (12) at both sides are fixed onto a casing seat (101).

### Second Embodiment

FIG. 3 depicts the second preferred embodiment of the present invention, wherein the major components of the driving device are arranged flexibly, namely, the wheels and bearing are configured onto the drive shaft (13) in sequence, including: the first weight wheel (141), the drive bearing (122), the second weight wheel (142), the second driving wheel (152), the first driving wheel (151), the third weight wheel (143), the drive bearing (122) and the fourth weight wheel (144). In this way, said generator (2) and electric motor (3) can be placed between the second weight wheel (142) and third weight wheel (143), so the second preferred embodiment of the driving device of the present invention can be used in long and narrow environment.

Said generator (2) is a GR-66 micro generator, or a GR-22A generator. Said electric motor (3) employs a motor to drive the input end of the driving device (1). Said electrical storage device (4) consists of a first battery (41) as a primary power supply, a second battery (42) as a secondary power supply, a battery holder (43) for holding two batteries (41, 42), and a sensing circuit within the battery holder (43). In the case of shortage of power supply from the first battery (41), the second battery (42) is charged to the first battery (41), whilst the current generated by said generator (2) will be stored into the second battery (42) through rectifier and electrolytic capacitor in the battery holder (43). The electrical storage device (4) is used to provide the electric energy required for startup of the motor and the voltage required for stable operation of the motor.

### Third Embodiment

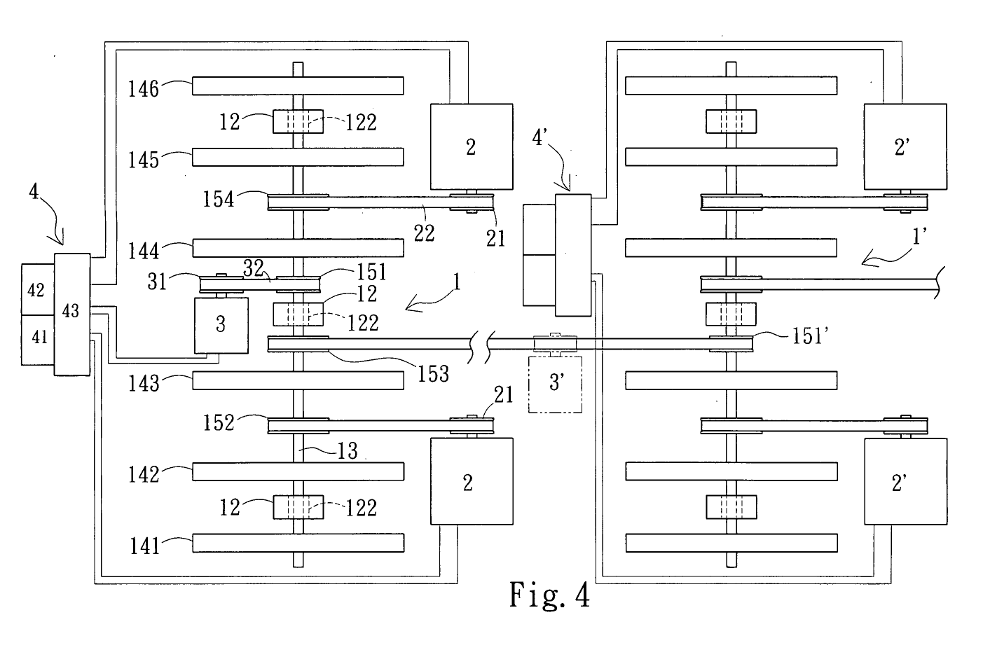

FIG. 4 depicts the third preferred embodiment of the present invention, wherein the major components of the driving device are arranged in another scheme. The original driving device (1) is additionally provided with fifth weight wheel (145) and sixth weight wheel (146), as well as two second driving wheels (153, 154); so the wheels and bearing are configured onto the drive shaft (13) in sequence, including: the first weight wheel (141), the drive bearing (122), the second weight wheel (142), the second driving wheel (152), the third weight wheel (143), the second driving wheel 153, the drive bearing (122), the first driving wheel (151), the fourth weight wheel (144), the second driving wheel (154), the fifth weight wheel (145), the drive bearing (122) and the sixth weight wheel (146).

In the preferred embodiment, two second driving wheels (152, 154) are used to drive separately the rotating discs (21) of two generators 2, and the other second driving wheel 153 used to drive the first weight wheel (151) of the other driving device (1′); so the driving device (1) of the present invention can be connected in series with the other same driving device (1′), and taken as a power supply for the driving device (1′) in the case of failure of the electric motor (3′) of the driving device (1′). In addition, the battery of the other electrical storage device (4′) can be removed to replace the battery of the electrical storage device (4), or a switch gear can be arranged to enable the connection of the electric motor (3) with the other electrical storage device (4′) for the power supply, when the power shortage of electrical storage device is detected.

1. A driving device of an electric motor, wherein an input end of a driving device (1) is driven by an electric motor (3), and an output end of the driving device (1) supplies power to a generator (2), which permits the generated electric power to be stored into an electrical storage device (4); then, said electrical storage device (4) supplies power to said electric motor (3) and drives the driving device (1);
it is characterized by that:
said driving device (1) comprises: pluralities of support bars (12) arranged at interval, a drive shaft (13) penetrating a coupling portion of the support bars (12), at least four weight wheels (141, 142, 143, 144) penetrated and secured by the drive shaft (13), a first driving wheel (151) pivotally mated with the drive shaft (13) and driven by the electric motor (3), and at least a second driving wheel (152) pivotally mated with the drive shaft (13) and used to energize the generator (2); said weight wheels (141˜144) are arranged at both sides of every support bar (12) in pairs, so that the driving device (1) forms a first driving portion (1a) and a second driving portion (1b), and the support bar (12) is fitted with a drive bearing (122) penetrated by the drive shaft (13).

2. The driving device of claim 1, wherein the wheels (141˜144,151,152) and bearing (122) of said driving device (1) are configured onto the drive shaft (13) in sequence, including: the first driving wheel (151), the first weight wheel (141), the drive bearing (122), the second weight wheel (142), the third weight wheel (143), the drive bearing (122), the fourth weight wheel (144) and the second driving wheel (152).

3. The driving device of claim 1, wherein said driving device (1) is placed into a fixed casing (10) with an opening (11); an inner wall surface of the casing (10) is provided with at least four mobile rings (50) that are arranged correspondingly to the weight wheels (141˜144) and used to cover the periphery of the weight wheel; the mobile ring (50) is composed of an inner ring (51) covering the periphery of the weight wheel, an outer ring cover (52) mated onto the inner wall of the casing (10) at a spacing with the inner ring (51), and pluralities of balls (53) arranged between the inner ring (51) and outer ring cover (52) to surround the inner ring (51).

4. The driving device of claim 1, wherein said casing (10) is composed of a casing seat (101) and two casing covers (102, 103) separately at two parts of the casing seat (101), enabling said opening (11) to be formed between two casing covers (102, 103); moreover, at left and right bottom of the casing (10), lubrication grooves (104, 105) are set for the balls (53) of said mobile ring (50).

5. The driving device of claim 1, wherein a recess (14a) is arranged at half-side of every weight wheel (141˜144) and a projection (14b) at the other half-side, such that an included angle (θ) is formed between the projection (14b) and recess (14a) of a weight wheel and a projection (14b′) and a recess (14a′) of another weight wheel.

6. The driving device of claim 1, wherein the wheels (141˜144,151,152) and bearing (122) of the driving device (1) are configured onto the drive shaft (13) in sequence, including: the first weight wheel (141), the drive bearing (122), the second weight wheel (142), the second driving wheel (152), the first driving wheel (151), the third weight wheel (143), the drive bearing (122) and the fourth weight wheel (144).

7. The driving device of claim 1, wherein said driving device (1) is additionally provided with a fifth weight wheel (145) and a sixth weight wheel (146), as well as two second driving wheels (153, 154); so the wheels and bearing are configured onto the drive shaft (13) in sequence, including: the first weight wheel (141), the drive bearing (122), the second weight wheel (142), the second driving wheel (152), the third weight wheel (143), the second driving wheel (153), the drive bearing (122), the first driving wheel (151), the fourth weight wheel (144), the second driving wheel (154), the fifth weight wheel (145), the drive bearing (122) and the sixth weight wheel (146).
